(19) United States
(12) Patent Application Publication
(10) Pub. No.: US 2009/0074278 A1
(43) Pub. Date: Mar. 19, 2009

(54) METHOD AND APPARATUS FOR METAL ARTIFACT REDUCTION IN COMPUTED TOMOGRAPHY

(75) Inventors: Luc Beaulieu, Quebec (CA); Mehran Yazdi, Shiraz (IR)

Correspondence Address: CANTOR COLBURN, LLP, 20 Church Street, 22nd Floor, Hartford, CT, 06103, US

(73) Assignee: UNIVERSITE LAVAL, Quebec, QC (CA)

(21) Appl. No.: 11/577,041

(22) PCT Filed: Oct. 12, 2005
(86) PCT No.: PCT/CA05/01582

§ 371 Date: Oct. 15, 2008

Related U.S. Application Data
(60) Provisional application No. 60/617,058, filed on Oct. 12, 2004.

(51) Int. Cl. G06K 9/00

(52) U.S. Cl. 382/131

(57) ABSTRACT

A method for reducing artifacts in an original computed tomography (CT) image of a subject, the original (CT) image being produced from original sinogram data. The method comprises detecting an artifact creating object in the original CT image; re-projecting the artifact creating object in the original sinogram data to produce modified sinogram data in which missing projection data is absent; interpolating replacement data for the missing projection data; replacing the missing projection data in the original sinogram data with the interpolated replacement data to produce final sinogram data; and reconstructing a final CT image using the final sinogram data to thereby obtain an artifact-reduced CT image.

### BACKGROUND OF THE INVENTION

The application of CT (Computed Tomography) in radiation therapy treatment planning has tremendously increased in recent years. Indeed, the CT information is essential in two aspects of treatment planning: a) delineation of target volume and the surrounding structures in relation to the external contour; and b) providing quantitative data, i.e. the attenuation coefficients converted into CT numbers in units of Hounsfield, for tissue heterogeneity corrections. For instance, in the treatment of prostate cancer, contouring the prostate and simulating the dose distribution are essential for planning. Meanwhile, the image artifacts produced by metal hip prostheses (see FIG. 1), referred as metal artifacts, make the planning extremely difficult. In any cases, prostheses must be avoided at the time of planning (TG63).

Metal artifacts are a significant problem in x-ray computed tomography. Metal artifacts arise because the attenuation coefficient of a metal in the range of diagnostic X-rays is much higher than that of soft tissues and bone. The results of scanning a metal object are gaps in CT projections. The reconstruction of gapped projections using standard CT reconstruction algorithms, i.e. filtered backprojection (FBP), causes the effect of bright and dark streaks in CT images (FIG. 1). This effect significantly degrades the image quality in an extent that modern planning process cannot be applied.

Many different techniques have been proposed to reduce metal artifacts in literature. Some techniques suggested to replace the metal implants with less attenuating materials or to use higher energy x-ray beams for preventing metal artifacts. Others used image windowing techniques to reduce the appearance of artifacts in the images. However, these case-by-case solutions are not ideal for most clinical applications. The most efficient methods work on the raw projection data, i.e. the matrix of ray attenuations related to different angles acquired by the CT scanner. In iterative reconstruction methods, the projection data associated with metal objects are disregarded and reconstruction is applied only for non-corrupted data. Briefly, in these methods, an initial guess of the reconstructed image is made and then the projections obtained of this initial image are compared to the raw projection data. By iteratively reconstructing projection ratios and applying an appropriate correction algorithm for initial image, an improved estimate of the image is obtained. Although these algorithms are reliable for incomplete/noisy projection data, they must deal with convergence problems and they are computationally expensive for clinical CT scanners (even with their fast implementation). In projection interpolation based methods, the projection data corresponding to rays through the metal objects are considered as missing data. A prior art technique identified manually the missing projections and replaced them by interpolation of non-missing neighbor projections. A prior art technique used a linear prediction method to replace the missing projections. In other work, a polynomial interpolation technique is used to bridge the missing projections. A wavelet multiresolution analysis of projection data is also proposed to detect the missing data and interpolate them. Although these methods do not increase significantly the computational cost, they have achieved varying degrees of success and appear to depend on the complexity of the structures examined and may still result in artifacts in the final reconstruction.

A prior art technique uses another strategy for computing the interpolation value by the sum of weighted nearest not-affected projection values within a window centered by the missing projection. The weights are modeled only based on the distance. Although they exploit the contribution of not-affected projections in all directions to determine the replacement values, they do not preserve the continuity of the structure of these projections. Furthermore, because there is no continuity between resulting replacement values, the risk of noise production is also high. In a prior art technique, we used an optimization scheme exploiting both the distance and the value of not affected projections to determine the interpolation values and by using still an interpolation scheme to preserve the continuity of replacement values. This new scheme computed more effectively the interpolation values based on the structure of nearest not affected projections and resulted an excellent performance in the case of hip prosthesis.

Although the interpolation-based methods do not increase significantly the computational cost and achieve a good degree of success in image quality for the case of hip prosthesis, their performance is severely degraded in the presence of multiple and closed metallic objects such as dental fillings. Indeed, these methods are so sensitive to the correct detection of the missing projections. When multiple and closed metallic implants are present in the field of view of scanner, it is so difficult to exactly distinguish the missing projections due to each metallic objects by the sinogram. Consider the case of dental fillings (FIG. 8). As we can see, because metallic objects are small with different shapes/sizes and placed near to each other, their detection becomes extremely difficult. Moreover, when the mouth is closed and a continuous scanning is done from head to feet, the structure of adjacent dental fillings from up-teeth to down-teeth changes suddenly which give rise to more difficulties for their detection. So, the interpolation-based methods have to consider a large region as missing projections in the sinogram to cover all metallic projections and then replace most relevant data by synthetic data. As a consequence, anatomic details between and surrounding the multiple metallic implants are totally missing. It arises more difficulties for radiation oncology where the quantitive analysis of CT images is essential for accurate structure contouring and dose calculation. Thus the needs to develop more sophisticated metal artefact reduction (MAR) algorithms especially for complex cases such as dental fillings.

A prior art technique proposes an adaptive filtering approach for MAR. First a tissue class model is created from initial CT image. Then a model sinogram is generated using this class and compared with original sinogram to identify and to replace missing projection. The difference between original and model sinograms is downscaled and then filtered adaptively. The corrected sinogram is used to regenerated the CT image. Although they used a more sophisticated approach for the metal detection step, their replacement scheme cannot achieve a good estimation of original values for the case of dental implants and resulted many false labellings near the metallic implants A prior art technique studies the metal artifacts in the wavelet domain especially for the case of dental fillings. Their approach consists of using a scale-level dependent of linear interpolation of wavelet coefficients of sinogram to reveal the corrupted data and a linear-interpolation scheme to replace missing projections. Although the use of wavelet domain aids to more implicitly detection of metal traces due to multiple metallic objects in the sinogram, their replacement scheme has still disadvantages of interpolation based methods. Moreover, an extremely delicate optimal selection of weight parameters for wavelet interpolation is required in this algorithm.

Our observation is that a most efficient replacement scheme can afford a more sophisticated metal artifact reduction method especially for the complex case of dental fillings. We propose a new replacement scheme to modify the sinogram containing the missing projections by searching the relevant replacement values in the opposite direction of original values, contrary to interpolation based scheme in which replacement values are computed artificially using nearest non-affected projections. Although this new replacement scheme is also based first on detecting of metallic objects, it is much less sensitive to this step. This approach is especially applicable in Head and Neck cases with metal implants such as dental fillings and produces significantly better quality CT images than interpolation-based MAR algorithms.

### SUMMARY OF THE INVENTION

In an embodiment, the present invention provides a method for reducing artifacts in an original computed tomography (CT) image of a subject, the original (CT) image being produced from original sinogram data. The method comprises detecting an artifact creating object in the original CT image; re-projecting the artifact creating object in the original sinogram data to produce modified sinogram data in which missing projection data is absent; interpolating replacement data for the missing projection data; replacing the missing projection data in the original sinogram data with the interpolated replacement data to produce final sinogram data; and reconstructing a final CT image using the final sinogram data to thereby obtain an artifact-reduced CT image.

In an embodiment a CT scanner device capable of reducing artifacts in an original computed tomography (CT) image of a subject, the original (CT) image being produced from original sinogram data. The CT scanner comprising:
an X-ray source for providing X-rays;
X-ray detectors for detecting the X-rays;
a processing unit for producing the original CT image using the X-rays, the processing unit also for:
   detecting an artifact creating object in the original CT image;
   re-projecting the artifact creating object in the original sinogram data to produce modified sinogram data in which missing projection data is absent;
   interpolating replacement data for the missing projection data;
   replacing the missing projection data in the original sinogram data with the interpolated replacement data to produce final sinogram data; and
reconstructing a final CT image using the final sinogram data to thereby obtain an artifact-reduced CT image.

An approach for metal artifact reduction is proposed that is practical for use in radiation therapy. It is based on interpolation of the projections associated with metal implants at helical CT (computed tomography) scanner. The present invention comprises an automatic algorithm for metal implant detection, a correction algorithm for helical projections, and a more efficient algorithm for projection interpolation. Moreover, this approach can be used clinically as complete modified raw projection data is transferred back to the CT scanner device where CT slices are regenerated using the built-in reconstruction operator. So, all detail information on scanner geometry and file format is preserved and no changes in routine practices are needed. The validations on a CT calibration phantom with various inserts of known densities prove the efficiency of the algorithm to improve the overall image quality and more importantly to preserve the form and the representative CT number of objects in the image. The results of application of the algorithm on prostate cancer patients with hip replacements demonstrate the significant improvement in image quality and allow a more precise treatment planning.

There are no automatic and robust algorithms for metal artifact reduction which can be practical for routine clinical applications. The goal of this work is to investigate a clinical approach to effectively improve the quality of the helical CT images in the presence of metal artifacts for treatment planning process. The approach is based on the projection interpolation because of its simplicity and speed. The results are presented for both phantom and patient images obtained with a Helical-CT scanner (Siemens, Somatom).

This approach has three main advantages; i) the algorithm can be used clinically as we currently use it as a pre-processing technique for prostate treatment planning; ii) the metal markers which are used for virtual simulation planning are also another source of artifacts with a much lower degree of importance and should not be eliminated from CT images. These markers can be easily distinguished from other metal objects and will be maintained for other processing; iii) virtual simulation is a tool for planning and designing radiation therapy treatment. Since the virtual simulation needs the parameters produced during the patient scanning, we transfer the modified projection data back to the scanner device and use its built-in reconstruction operators. Thus, the routine application will be the same and all detail information on scanner geometry and file format will be maintained.

This clinical approach for metal artifact reduction can be successfully applied for the therapy treatment planning. This technique brings three improvements to the conventional approaches for metal artifact reduction using projection interpolation scheme. These improvements are adapted to the clinical application. The proposed algorithm can be applied for helical and non-helical CT scanners. In both phantom experiment and patient studies, the algorithm resulted in significant artifact reduction with increases in the reliability of planning procedure for the case of metallic hip prostheses. This algorithm is currently used as a pre-processing for prostate planning treatment in presence of metal artifacts.

### BRIEF DESCRIPTION OF THE DRAWINGS

These and other features, aspects and advantages of the present invention will become better understood with regard to the following description and accompanying drawings wherein:

FIG. 1 shows an example of artifacts produced by scanning a patient with two hip prostheses using a prior art Siemens Somatom scanner;

FIG. 2. shows an example of missing projection detection; (a) raw projection data, (b) initial reconstructed image, (c) metal object segmentation, (d) case of using markers, (e) markers in the exterior of patient body contour, (f) missing projections in raw projection data;

FIG. 3 shows an example of missing projection correction for helical projection; (a) intensity profile at a given angle, (b) initial contouring of the missing projections, (c) final contouring of the missing projections, (d) gradient curve of the intensity profile in FIG. 3(a), (e) zooming the block in FIG. 3(b), (f) zooming the block in FIG. 3(c);

FIG. 4 shows the results of the adaptive interpolation algorithm; (a) raw projection data and missing projections (black region), (b) result of applying the interpolation on each given angle (i.e. vertical lines), (c) artifact result of this interpolation scheme, (d) result of applying the adaptive interpolation, (e) reduction of artifacts in the reconstructed image;

FIG. 5 shows a phantom test; (a) original phantom image without inserting metallic rods, (b) presence of artifacts because of metallic rods, (c) result of artifact reduction algorithm, (d) result of applying an automatic edge detection algorithm on original phantom image, (e) on phantom image with metallic rods, (f) on artifact reduction image, (g) computing the mean and standard deviation for three objects in the middle of the phantom in original phantom image, (h) in phantom image with metallic rods, and (i) in artifact reduction image;

FIG. 6 shows a patient test; (a) Topogram of a patient with two hip prostheses, (b) reconstructed image using the Siemens Somatom scanner, (c) result of applying the metal artifact reduction algorithm;

FIG. 7 shows the DRR results; (a) Original case with two hip prostheses, (b) after applying the metal artifact reduction algorithm, (c) after overriding the prostheses information into the result of metal artifact reduction; and

FIG. 8 shows another example of artifacts produced by scanning a patient with dental implants using a Siemens Somatom scanner;

FIG. 9 shows an embodiment of the procedure of missing projections detection; a) original sinogram, b) reconstructed CT image, c) metallic object detection, d) reprojection of metallic objects into the sinogram. Black areas are detected missing projections;

FIG. 10 shows the geometry of an equiangular fan-beam. All angles are positive as shown;

FIG. 11 shows the geometry of opposite angular positions;

FIG. 12 shows the projections and their opposite sides in the sinogram;

FIG. 13 shows a sinogram replacement scheme strategy according to an embodiment. The black area is missing projections. A′B′ and C′D′ are the opposite sides of AB and CD respectively. Arrows show the directions of replacing sheme;

FIG. 14 shows an example of a topogram for a patient with dental fillings;

FIG. 15 shows a sinogram of a patient (human) scanned by a Siemens Somatom scanner;

FIG. 16 shows a CT image sequence reconstructed using the sinogram of FIG. 15;

FIG. 17 shows a modified sinogram (also referred to herein as final sinogram) using the replacement scheme;

FIG. 18 shows a CT image sequence reconstructed using the modified sinogram of FIG. 17 where CT images have the same level of contrast as those in FIG. 16; and

FIG. 19 shows a comparison of the proposed approach with interpolation-based method; a) original CT image, b) result of applying interpolation based method, c) result of applying the proposed approach.

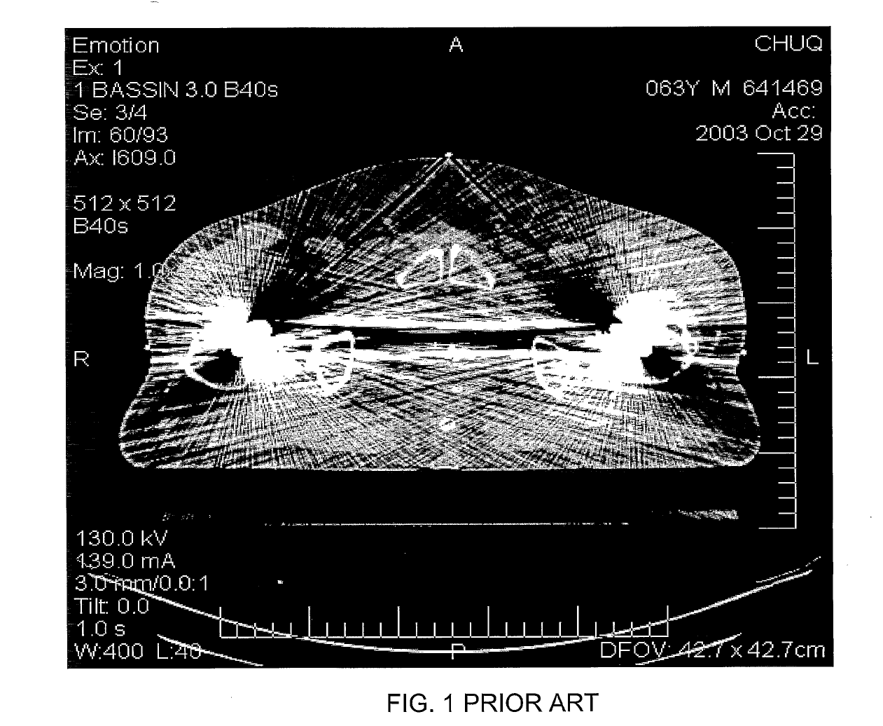

### DETAILED DESCRIPTION OF THE PREFERRED EMBODIMENT

### Method and Materials

In a first example, the algorithm is based on the interpolation of missing projections in raw projection data. The modified projection data is used to generate slice images by scanner standard reconstruction algorithm. No further modification in the employed operators is required for this reconstruction. The resulting tomographies are still subject to minor artifact in the area near to the boundary of metal implants, but there are significant gains in image quality for regions of interest such as prostate.

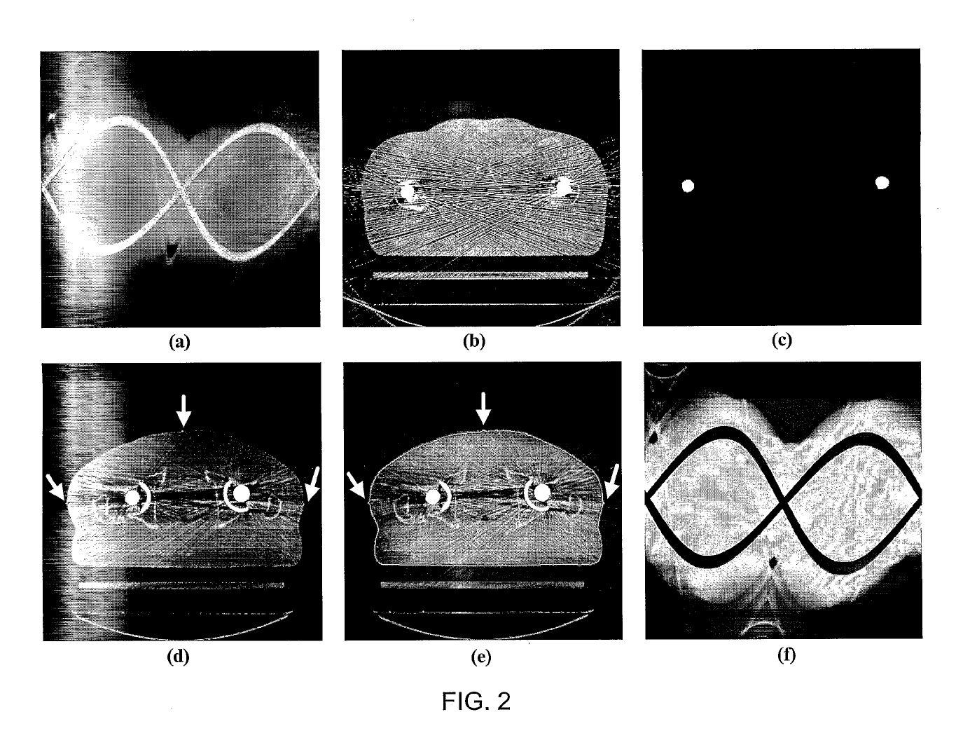

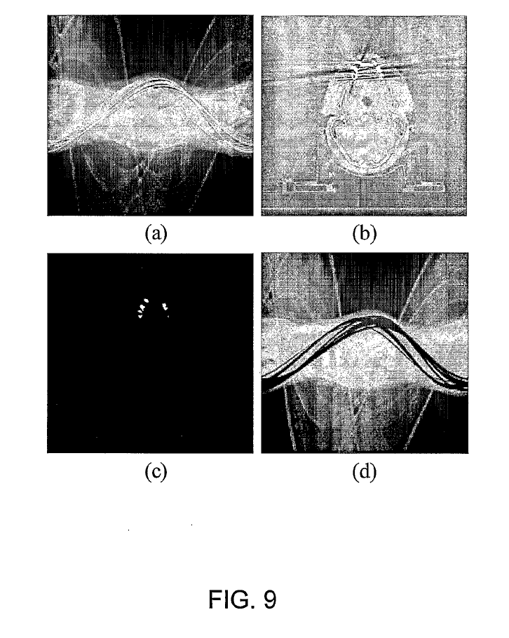

Three extensions are introduced: the first step is to detect the projections affected by metal implants. Some authors proposed to isolate the correspondence of the metal implants directly from the projection, but have difficulties to fix the appropriate thresholds because of the complex structure of the projection data. Others are identifying the sinusoidal curves resulting from metal implant in the projection data. Although these approaches are interesting, they still need to fix some parameters and studies are limited to parallel projections. In this algorithm, the metal prostheses are identified quasi-automatically from reconstructed images. First, we reconstruct an initial image from the 360 degrees raw helical projection data using fan-beam FBP (see FIGS. 2(a) and 2(b)). Since the metal objects produce high-value-connected pixels in the initial image, a fixed fraction of the maximum value found in the initial image is used as the threshold for detecting the metal objects (see FIG. 2(c)). In this way, the threshold will be automatically determined in each reconstructed image. The metal markers are routinely used at exterior of patient body as reference points for planning procedure and should be preserved. They can be easily distinguished from metal implants in the initial image. To do so, the exterior contour of the patient body is detected in the initial image (see FIGS. 2(d) and 2(e)) and all metal objects on this contour are considered as markers which will be used for virtual simulation. Finally, the metal implant regions in the initial image are reprojected using a fan-beam projection algorithm to obtain approximate missing projections in the raw projection data (the black areas in FIG. 2(f)). These missing projections are next replaced by synthetic data using an interpolation scheme. Another example of the missing projection detection is shown in FIGS. 9 a) to 9 d).

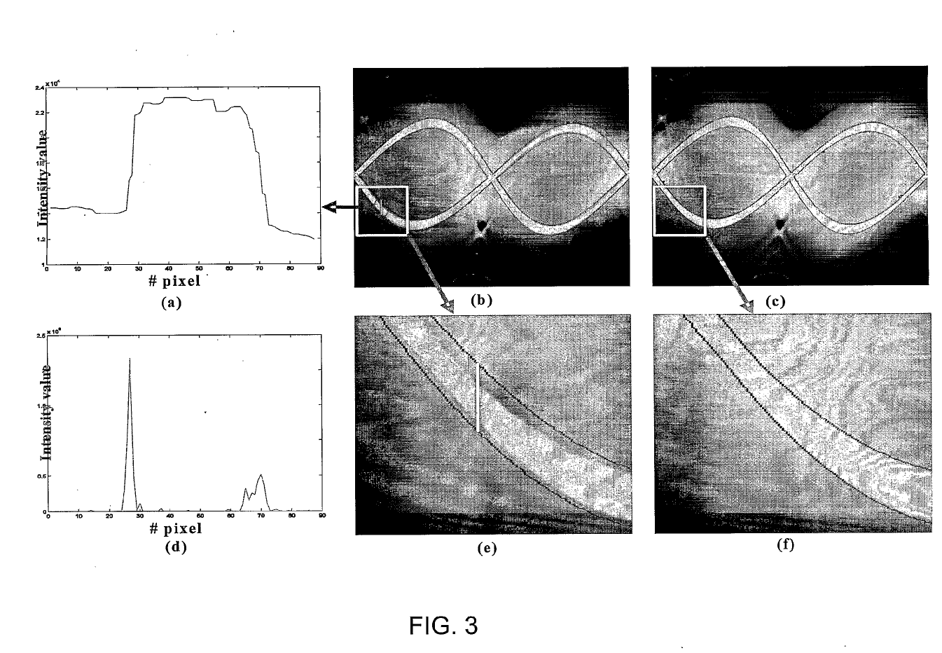

In helical scanning, the patient is transported continuously as the tube and detector rotate around the patient. So, during one rotation (360 degrees) of tube, the patient may be translated from 1 mm to 10 mm for typical procedures. In this interval, the metallic prostheses may change orientation or undergo a deformation. To precisely detect the missing projections in helical raw projection data, we make a correction for reprojected metal implant regions adapted to these changes. FIG. 3(a) shows a vertical intensity profile at a given angle through the metal trace in FIGS. 3(b) and 3(e). Plotted on the y-axis is the projection intensities as a function of position (x-axis). As we can see the peak represents the projection of metallic implant at this given angle. To precisely determine the projected edges, we compute its gradient curve (FIG. 3(d)). The first peak and the last peak in this curve represent the projected edges and consequently the missing projections over which interpolation needs to be applied. We continue this step for all vertical lines in projection data to correctly determine the missing projections. FIGS. 3(c) and 3(f) show the results for corrected reprojected metal implant regions.

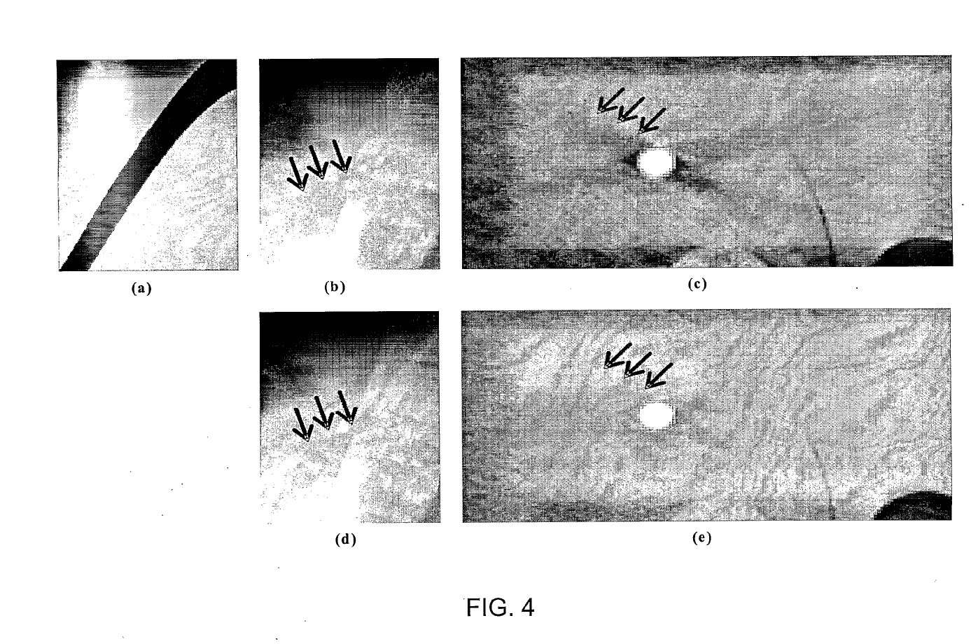

In conventional algorithms for replacing the missing projection, an interpolation scheme is generally applied using the projected edges for the same view angle. Although this strategy reduced the artifacts due to metal objects, the resulting tomographies are still subject to additional artifacts. Indeed, these additional artifacts are due to the destruction of boundary of other objects in the area of interpolated projections. FIGS. 4(a), 4(b), and 4(c) show an example of this situation and its resulting additional artifact. Based on this observation, a more efficient algorithm was used to preserve the structure of adjacent projections during the interpolation. The idea is to apply the interpolation scheme between the two corresponding projected edges belonging to the projection regions of the same object. To do this, a set (m) of projected edges is determined on one side of a reprojected metal implant region and another set (n) is determined for other side of this region using the algorithm presented in step 2. Then for each projected edge belonging to m, we find the corresponding projected edge in n so that their distance and difference values are minimized. Let pixels Pₖ (k belongs to m) and Pⱼ (j belongs to n) be the projected edges. We defined the function D as the distance between Pₖ and Pⱼ:

$${D}_{( {P}_{k} , {P}_{j} )} = \sqrt{{( {x}_{{p}_{k}} - {x}_{{p}_{j}} )}^{2} - {( {y}_{{p}_{k}} - {y}_{{p}_{j}} )}^{2}} , \qquad ( 1 )$$

where x and y are the coordinates of a projected edge in the sinogram. Because the difference of only two projected edges is not reliable to determine that they belong to the same object, we select a group of adjacent projected edges around them to define the function of difference values V:

$${V}_{( {P}_{k} , {P}_{j} )} = {\sum }_{i} \vert {I}_{{P}_{k + i}} - {I}_{{P}_{j + i}} \vert , i = - N , … , N \qquad ( 2 )$$

where I is the intensity value of a projected edge and N is the size of the group surrounding each projected edge (in this case N=2).

This goal is to find for each Pₖ the best Pⱼ that optimizes simultaneously these functions. This type of problem is known as either a multiobjective, multicriteria, or a vector optimization problem. Many techniques have been proposed to solve this problem. We applied a min-max optimization method using Eq. (1) and Eq. (2) to determine the corresponding projected edges in both sides of the reprojected metal implant regions. Finally, we use a linear interpolation between these two corresponding projected edges to replace the projections in the metal implant regions. We continue this for all set of projected edges. Finally, we apply a median filter (size of 5×5 pixels) to remove the isolated high value projections which may not be interpolated in metal implant regions. FIGS. 4(d) and 4(e) show the results in projection data and reconstructed image. As it can be seen, the continuity of boundary structures in the area of interpolated projections is maintained and the additional artifact is removed.

These steps are repeated for all raw projection data to remove and interpolate the projections affected by the implants. In a last step, the whole modified raw projection data is transferred back to reconstruction operator of CT scanner to regenerate slice images.

In a second example, the algorithm is based on replacing missing projections in sinogram by their unaffected correspondences in opposite direction. The modified sinogram is used to regenerate slice images by scanner standard reconstruction algorithm. No further modification in the employed operators is required for this reconstruction. The resulting tomographies by the proposed approach show significant improvements in image quality, especially for regions near the metallic implants, compared to those by interpolation-based approaches. In this work, we describe the algorithm for a helical scanner which is based on spiral projections. It is obvious that the extension of this work for a parallel projection will be trivial. The approach is composed of three steps.

### Step 1: Missing Projection Detection

First step is to detect the projections affected by metal implants. Some authors proposed to isolate the correspondence of the metal implants directly from the projection, but have difficulties to fix the appropriate thresholds because of the complex structure of the projection data. Others are identifying the sinusoidal curves resulting from metal implant in the projection data. Although these approaches are interesting, they still need to fix some parameters and studies are limited to parallel projections. In our algorithm, the metal objects are identified quasi-automatically from reconstructed images. First, we reconstruct an initial image from the 360 degrees raw helical projection data using fan-beam FBP (see FIGS. 9(a) and 9(b)). Since the metal objects produce high-value-connected pixels in the initial image, a fixed fraction of the maximum value found in the initial image is used as the threshold for detecting the metal objects (see FIG. 9(c)). In this way, the threshold will be automatically determined in each reconstructed image. Finally, the metal implant regions in the initial image are reprojected using a fan-beam projection algorithm to obtain approximate missing projections in the raw projection data (the black areas in FIG. 9(d)). These missing projections are next replaced by synthetic data from the next step.

### Step 2: Replacing Scheme

For the following discussion we focus our attention on the helical CT single-slice scanner. The results can be extended to multi-slice and cone-beam scanners.

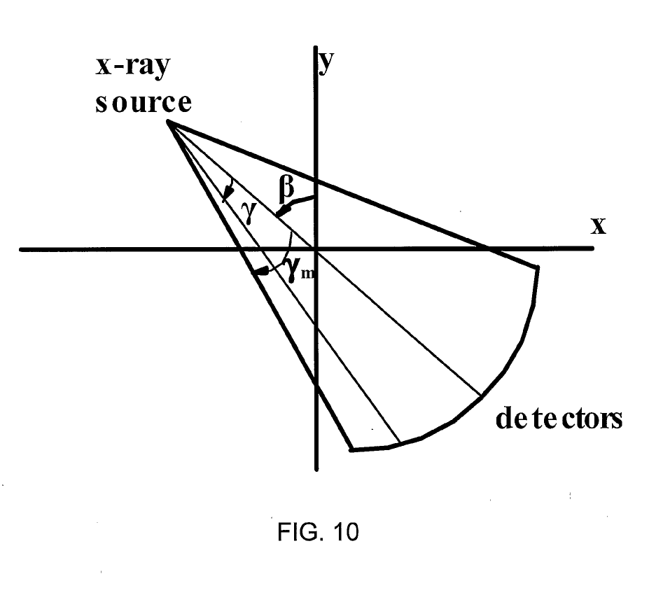

In helical scanning the patient table is transported continuously as the tube and 1D detector array rotate around the patient. The geometry of this scanning is shown in FIG. 10. We consider an equiangular fan-beam geometry in which the detectors lie on an arc of a circle. Let the x-rays project into the xy-plane and the direction normal to this scan plane be z. The view and detector angles are denoted β in the range (0,2π) and y in the range (−γₘ, γₘ).

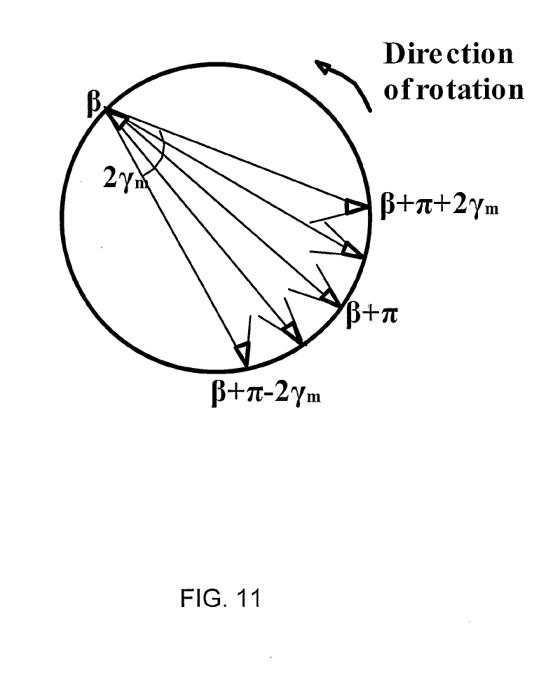

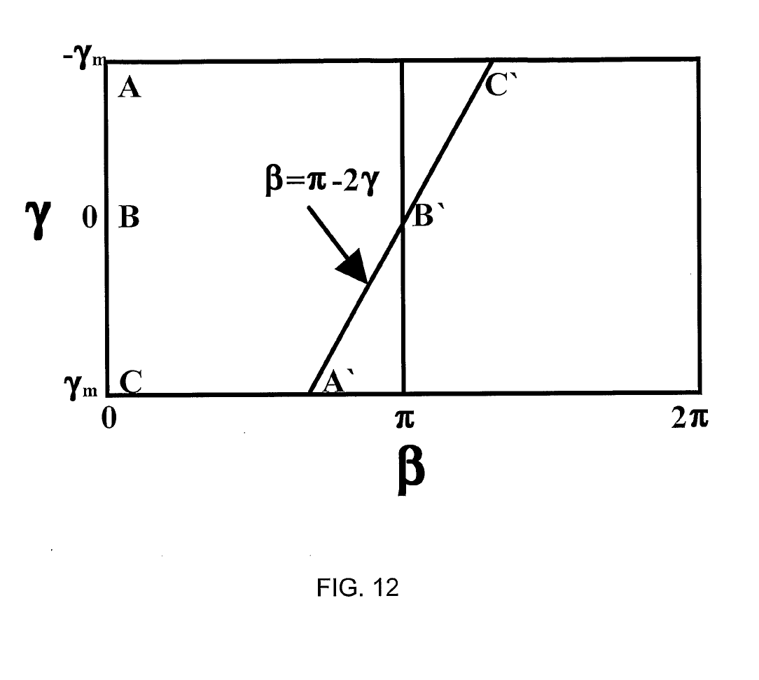

The idea behind the replacing scheme is due to the fact that the two projections along the same path but in the opposite sides would be the same in the absence of table motion. So, in the presence of table motion which is a real case for a CT exam, the opposite side projections are still very good approximations for the corresponding projections. The question is how we can compute the opposite side of a projection since in a fan-beam scanner the opposite sides are not exactly in 180 degrees apart. FIG. 11 shows the corresponding paths for computing the opposite angular positions. As we can see the opposite side of an x-ray beam (or a projection) depends on the position (or y) of this beam in the x-ray source. More clearly, a description of projections and their opposite sides is given with reference to FIG. 12 showing the γ vs β space (or sinogram). The letters A, B and C show the projections at β=0. The letters A′, B′ and C′ are showing the opposite side of the projections A, B and C respectively. Note that only for B which is a projection at γ=0, the opposite side lies on β=π. For other projections the opposite sides lie on a line where β=π−2γ. Thus, for each projection in the sinogram, its opposite side can be computed. However, because projections are given in discrete domain upon a finite uniform grid and not in a continuous form, interpolation is required in order to estimate the value of the required opposite side projections. We perform a bicubic interpolation using four nearest projections to compute the value of opposite sides.

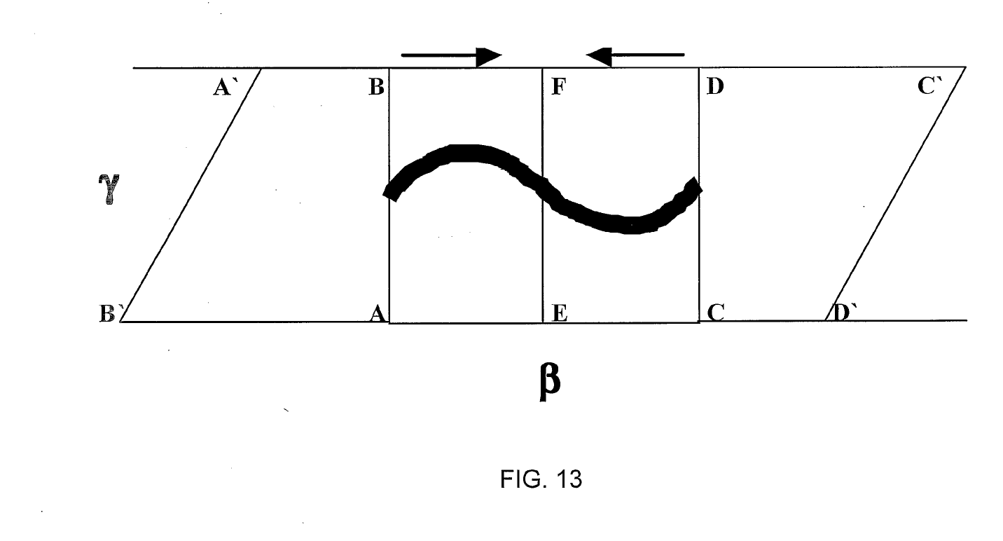

The replacing scheme is followed by firstly projecting the metal components of the CT image, as identified in the step 1, onto the original sinogram, to detect missing projections and then by replacing each missing projection by its opposite side. When the replacement scheme is started for the first missing projections in the sinogram, they are replaced by their non-affected-by-metallic-object projections in opposite side. But, as we progress the replacing scheme for other missing projections, their opposite side projections may be the missing projections already replaced by their own opposite sides. Consequently, there is a risk that the errors in each step of replacing scheme are accumulated so that the synthesize date for replacing scheme become totally unreliable. Actually, this is the reason why we are limited to use the replacing scheme for the metallic objects with small size which appear in a limited number of CT slices. In order to make the replacing scheme more reliable, we propose to start it simultaneously from each side of missing projections area. FIG. 13 illustrates this strategy. We start replacing the missing projections (the black area) from AB to EF by their opposite side projections from left side of sinogram and simultaneously from CD to EF by their opposite side projections from right side of sinogram. It results a less accumulation of errors and therefore improves the performance of the replacing scheme. Finally a smoothing filter (size of 5×5 pixels) is applied in the boundary of replacement regions to remove any possible discontinuities in adjacent projections and resulted additional artifacts.

### Step 3: Reconstruction of CT Images

The whole modified raw projection data arising from Step 2 is transferred back to reconstruction operator of CT scanner to regenerate slice images. So, all detail information on scanner geometry and file format is preserved and no changes in routine practices are needed.

### Results

### Phantom Data

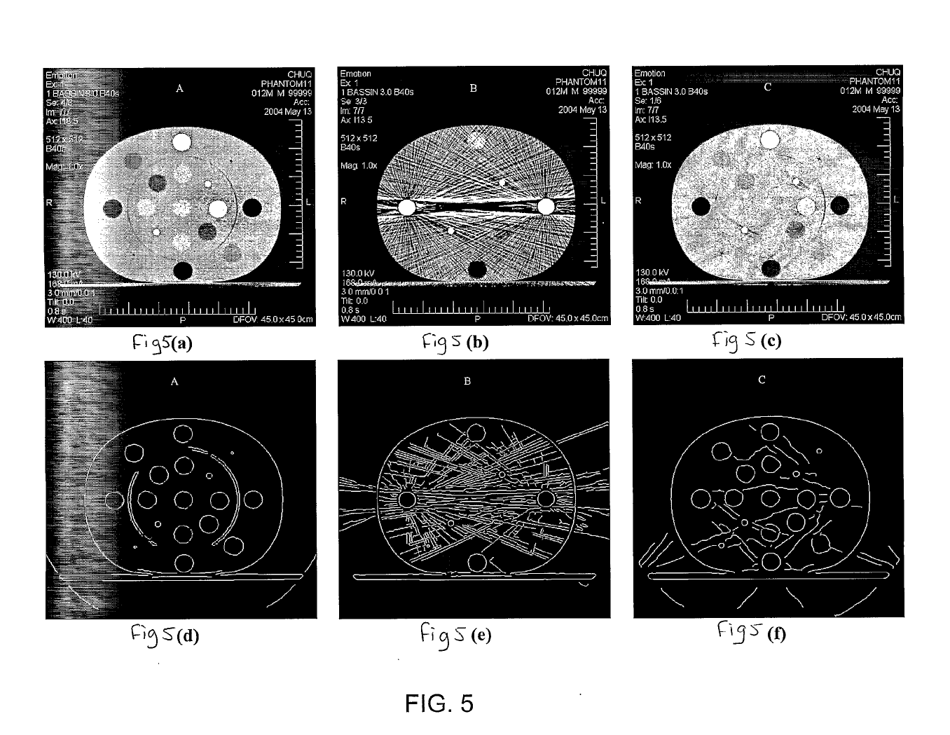

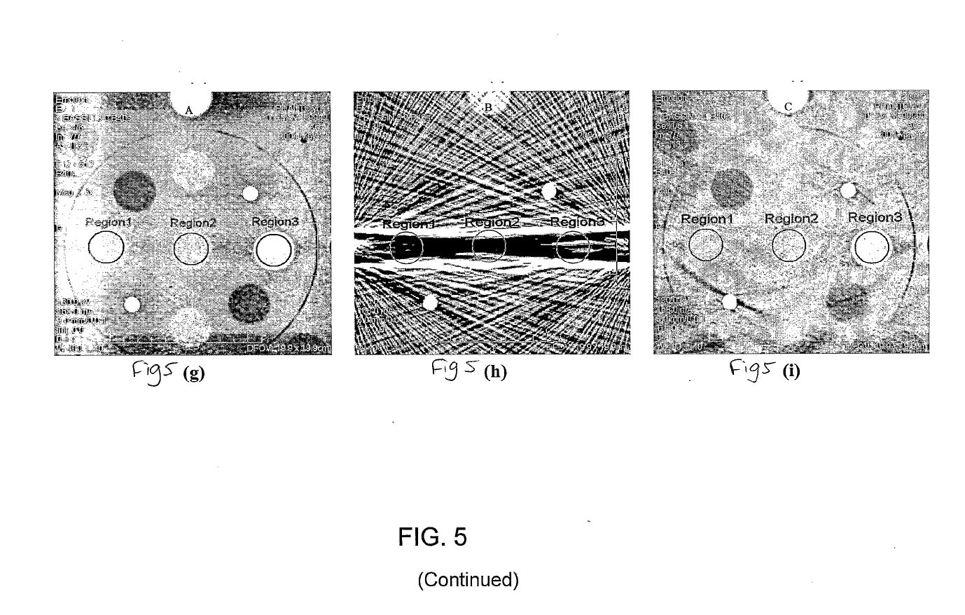

To quantitatively evaluate the performance of this algorithm for reducing metal artifacts, a phantom was used. This phantom is routinely employed for this CT scanner calibration. The phantom consists of several cylindrical inserts representing human organ densities (such as lung, muscle, liver, bone, etc.) embedded in a block of masonite in the form of human abdomen. We inserted two steel rods on each side of the phantom to represent the hip prostheses. The size of the rods was chosen to produce the same quantity of artifacts as in a real case. The phantom was scanned by a Siemens Somatom in helical mode with a pitch of 1.5 and 3-mm slice thickness with 130 kVp and 168 mA (which are the typical parameters for a pelvis scan) for two cases: without rods (case A) and with rods (case B). The raw projection data consisted of 1344 detectors and 1000 gantry positions in each tube rotation. FIGS. 5(a) and 5(b) show the original reconstructed images (512×512 pixels) for Case A and case B and FIG. 5(c) illustrates a significant improvement when the metal artifact reduction algorithm is applied on projection raw data of case B. We name this image case C. Two validations were used to evaluate the quality of images in cases B and C related to original case A.

Distortion validation: We applied a Canny edge detector to automatically detect the boundary of different objects in the phantom. We used the same parameters for the detector in three cases. FIGS. 5(d), 5(e), and 5(f) show the results for cases A, B, and C respectively. Many objects are missing in case B because artifacts are strong in their area. Especially, the detector cannot find the round objects located in the middle of the phantom and only the line segments representing the artifacts in the image are detectable. Meanwhile most round objects especially the three objects in the middle of the phantom can be successfully distinguished in case C. It proves that the algorithm not only improves the image quality but also it does not introduce any major deformation of the shape of the objects. When we try manually to find the objects in the image, all objects can be detected in case C.

CT number validation: We computed the statistical parameters of CT numbers, i.e. mean and standard deviation (std), for three regions representing the three objects in the middle of the phantom (see FIGS. 5(g), 5(h), and 5(i)). Table I resumes the results for cases A, B, and C. Comparing case B to the original case (A), we can see that the noise (std) is very high in case B and the mean values are negative and quite different for the three regions. On the other hand, in case C, the values are close to the original case and consequently represent the objects almost with the same material density as those in case A.

TABLE I
STATISTICAL PARAMETER COMPARISON

| | Region 1 | | Region 2 | | Region 3 | |
|---|---|---|---|---|---|---|
| | mean | std | mean | std | mean | Std |
| Case A | 47.4 | 19.8 | 57.7 | 21.3 | 238.7 | 20.9 |
| Case B | −189.3 | 360.8 | −272.2 | 432.5 | −94.2 | 325.6 |
| Case C | 37.0 | 24.3 | 42.1 | 30.3 | 215.6 | 26.3 |

From these validations, we conclude that the proposed approach improves the overall image quality and more importantly preserves the form and, in a large proportion, the representative CT number of objects in the image.

### Patient Data

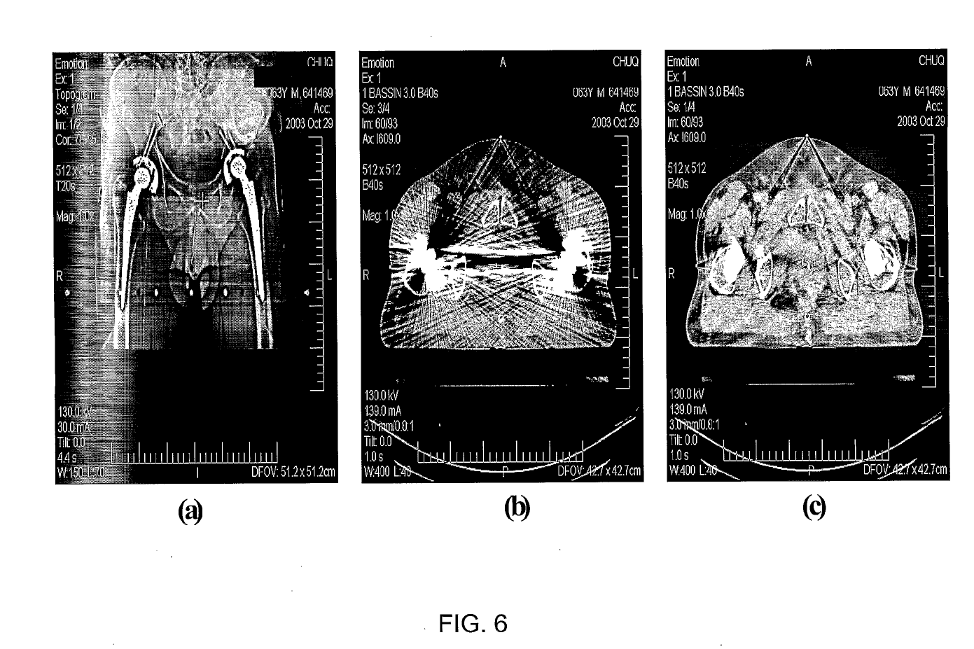

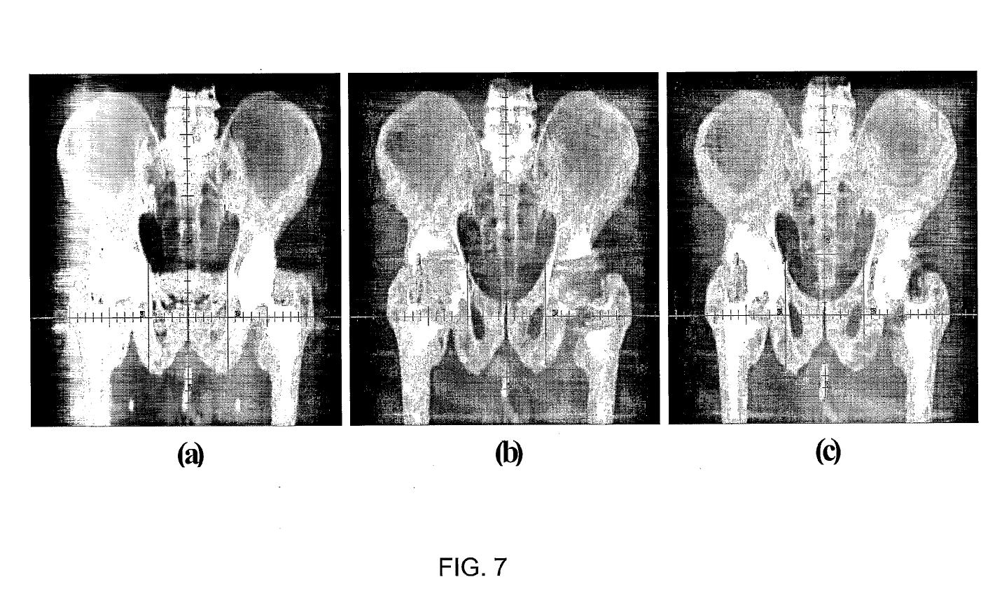

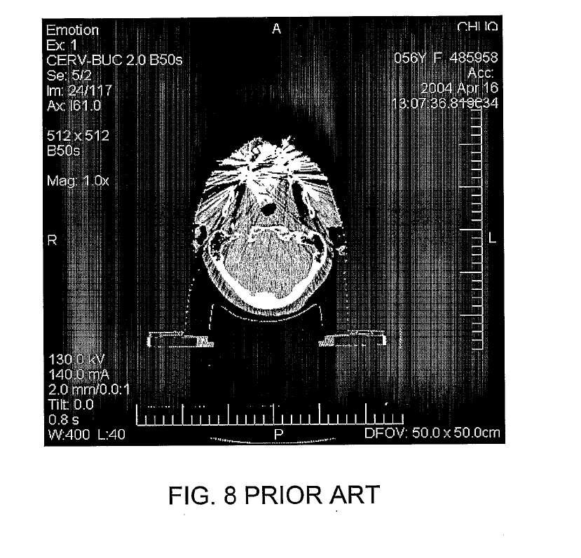

Many patients with hip prostheses are scanned each year at this institution. Recently, four patients with two hip prostheses were scanned and treated for prostate cancer in this institute. Here, we show the results for one of these patients. The same parameters as the above phantom experiment are used for the scanner. FIG. 6(a) shows the topogram for this patient. FIGS. 6(b) and 6(c) are representative slices of the patient and its modified image resulting from this artifact reduction algorithm. As it can be seen, the artifacts of two hip prostheses (FIG. 6(b)) are almost completely eliminated in FIG. 6(c). The remaining minor streaking artifacts are due to metal markers which are not removed by the algorithm. FIGS. 7(a) and 7(b) show DRR for original and modified cases using the complete image sequence.

Note that because of the interpolation step, information from the structures of metal implants is lost. We simply detect and contour the metal implants in the original images and then merge this information into the modified reconstructed images. Finally, we override the density inside the metal implant contours with a value closer to the real implant. FIG. 7(c) shows a DRR for this last modification.

Following recommendations from the report of task group 63 of the AAPM Radiation Therapy Committee, we basically plan beam arrangements that avoid prostheses to shadow the target. This kind of planning on patients with two hip prostheses requires precise delineation of the target and sensitive structures. The improvement in image quality provided by the metal artifact reduction algorithm enables this approach without compromising target dosage and normal tissue complication probabilities. Without image quality enhancement, physician would have drawn bigger margins to be sure to include the target and at the same time, would have prescribed lower dose in order to keep the same level of normal tissue toxicity.

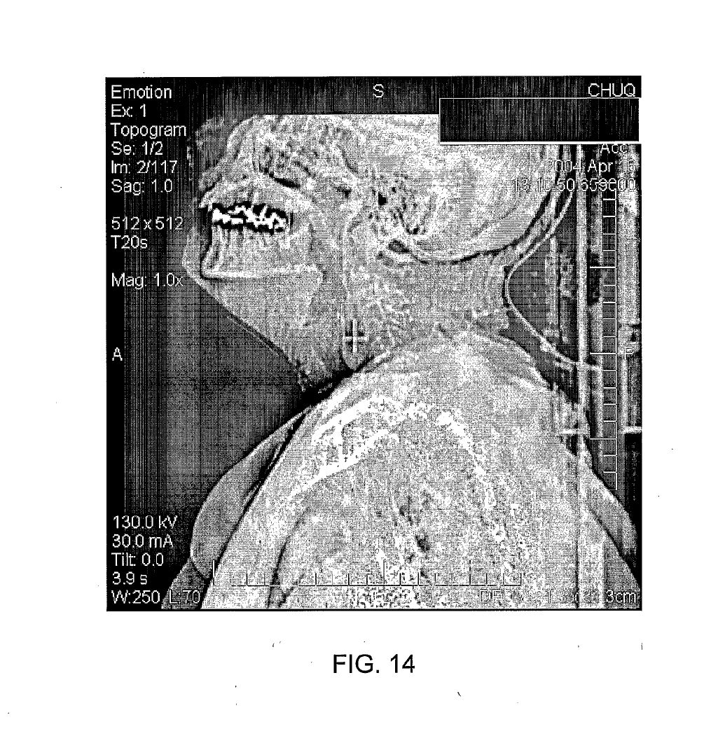

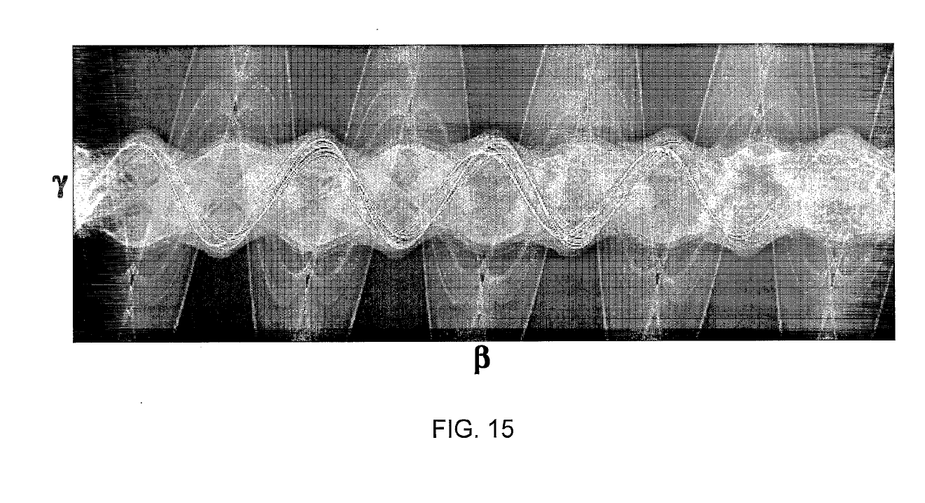

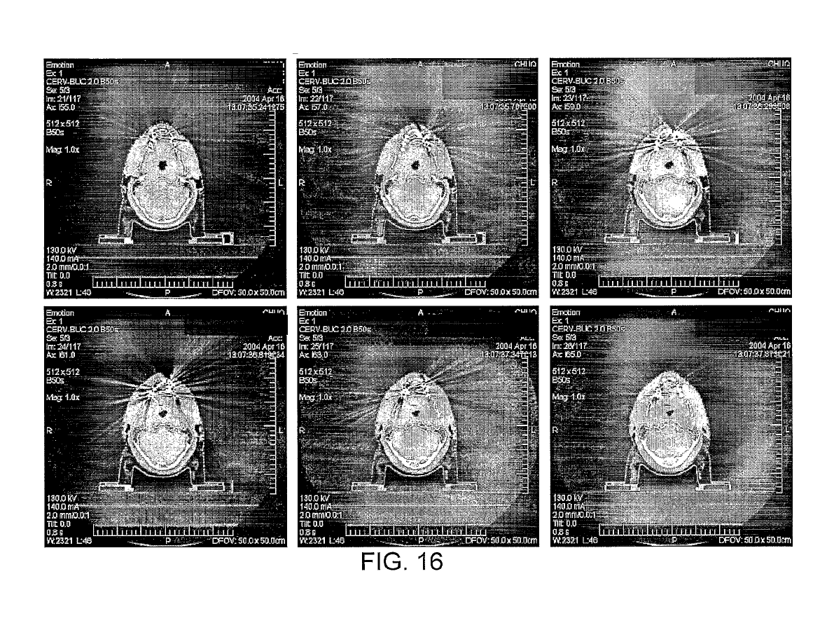

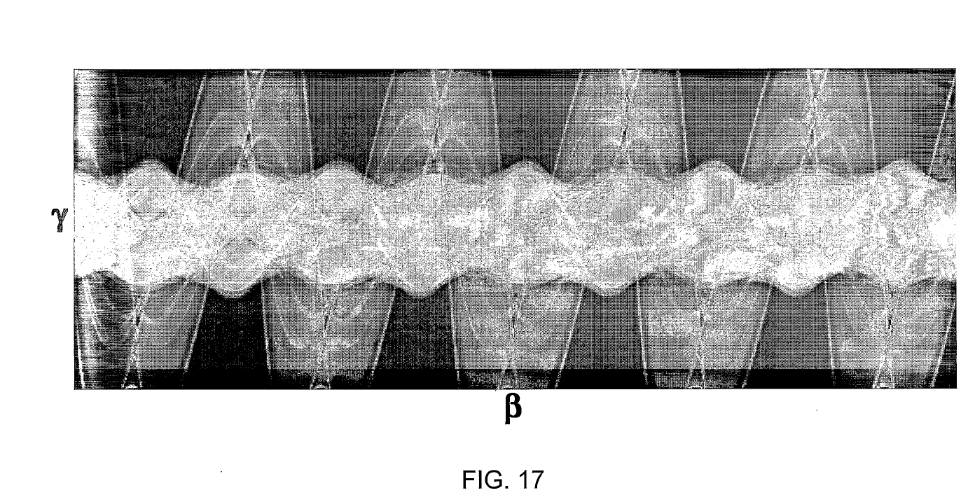

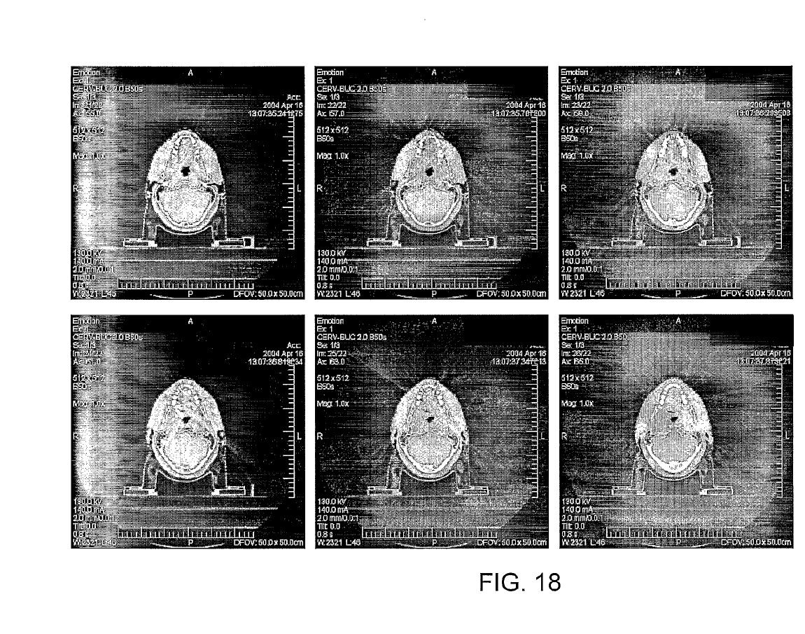

For a real patient with metallic teeth fillings, the topogram and a portion of the sinogram containing the affected projections by metallic objects are shown in FIGS. 14 and 15 respectively. FIG. 16 shows the sequence of CT images reconstructed by a Siemens Somatom scanner using this original sinogram. As we can see, strong streak artifacts are present in these CT slices. The modified sinogram resulted by applying the presented approach is demonstrated in FIG. 17. As seen, the trace of missing projections is completely removed and replaced by appropriate values. By transferring back the modified sinogram to the reconstruction operator of the scanner, CT images of FIG. 18 were obtained. Note that in FIGS. 16 and 18, the contrast (L=2321 and W=46) for all images is the same. All images in FIG. 18 compared with those in FIG. 16 show a superior image qualify. The images show almost no trace of artifacts, especially for teeth structures in which the details are very well revealed.

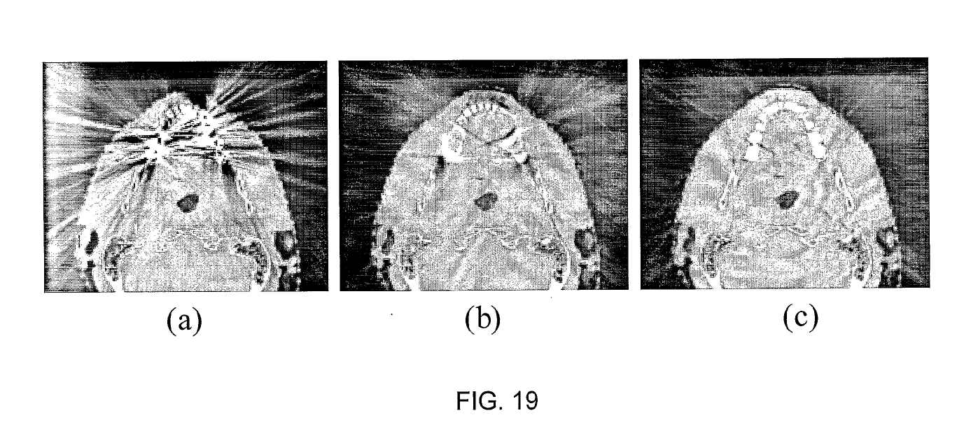

In order to evaluate the performance of the presented approach, we applied an interpolation-based algorithm on the same patient exam. FIG. 19 shows the results. The original CT image is shown in FIG. 19(a). The image reconstructed using the projection-interpolation algorithm is shown in FIG. 19(b). As we can see, because the image containing multiple adjacent metallic objects, interpolation was performed over a larger region of projection data. So, the interpolation becomes less reliable and the artefacts are not completely removed. In addition, the algorithm distorts the structure of the teeth directly adjacent to the metallic objects. As seen in FIG. 19(c), the presented approach almost completely eliminates the metal artefacts. Especially in regions directly adjacent to the metallic objects there is an increase in image quality.

Our proposed replacement scheme is independent from the type of metallic object. However, in metal detection step, the threshold depends favorably on Z so that for high Z materials, the threshold will be augmented and vice versa. Consequently, the detection step is automatically adjusted for a different Z objects. The approach is entirely automatic and can be used easily by relatively little user interaction. Additionally, since the Head and Neck tumour treatment planning is often performed while the patient is waiting, the approach does not increase the time to the planning process and it can be clinically applicable.

1. A method for reducing artifacts in an original computed tomography (CT) image of a subject, said original (CT) image being produced from original sinogram data, said method comprising:
detecting an artifact creating object in said original CT image;
re-projecting said artifact creating object in said original sinogram data to produce modified sinogram data in which missing projection data is absent;
interpolating replacement data for said missing projection data;
replacing said missing projection data in said original sinogram data with said interpolated replacement data to produce final sinogram data; and
reconstructing a final CT image using said final sinogram data to thereby obtain an artifact-reduced CT image.

2. The method of claim 1, wherein said detecting an artifact creating object comprises detecting high value-connected pixels in said original CT image, said high value-connected pixels being those which compose the artifact creating object.

3. The method of claim 2, wherein said high value-connected pixels in said original CT image comprises selecting pixels that have a value above a threshold as the high value-connected pixels.

4. The method of claim 3, wherein said threshold comprises a threshold value which is a fixed fraction of the maximum value for a pixel in the original CT image.

5. The method of claim 4, wherein said threshold value is determined automatically using pixel values in said original CT image.

6. The method of claim 5, wherein said artifact creating object comprises metal objects.

7. The method of claim 6. wherein said pixel values are dependent on a metal content of metal objects.

8. The method of claim 1, wherein said interpolating replacement data comprises using sinogram projection data from an alternate projection angle which is comparatively less affected by said artifact creating object than an original projection angle, said original projection angle being an angle from which missing projection data can be detected.

9. The method of claim 8, wherein said alternate projection angle comprises an angle which is substantially opposite said original projection angle.

10. The method of claim 9, wherein said opposite projection angle comprises an angle which is substantially 180 degrees apart from said original projection angle.

11. The method of claim 8, wherein all projection angles are predefined and further wherein said alternate projection angle comprises angles opposite the four projection angles which are nearest said original projection angle.

12. The method of claim 11, wherein said replacing said missing projection data comprises starting replacing said missing projection data with interpolated replacement data obtained from said opposite angle which are farther from an angle which is substantially 180 apart from said original projection angle.

13. The method of claim 8, wherein said interpolation comprises a bicubic interpolation.

14. The method of claim 1, wherein said subject comprises a part of the human body.

15. A CT scanner device capable of reducing artifacts in an original computed tomography (CT) image of a subject, said original (CT) image being produced from original sinogram data, said CT scanner comprising:
an X-ray source for providing X-rays;
X-ray detectors for detecting said X-rays;
a processing unit for producing said original CT image using said X-rays, said processing unit also for:
detecting an artifact creating object in said original CT image;
re-projecting said artifact creating object in said original sinogram data to produce modified sinogram data in which missing projection data is absent;
interpolating replacement data for said missing projection data;
replacing said missing projection data in said original sinogram data with said interpolated replacement data to produce final sinogram data; and
reconstructing a final CT image using said final sinogram data to thereby obtain an artifact-reduced CT image.
